(19) United States
(12) Patent Application Publication
(10) Pub. No.: US 2026/0203235 A1
(43) Pub. Date: Jul. 16, 2026

(54) MANAGING ADDRESS SPACE IN REGISTER BANK OF SYSTEM BASIS CHIP

(71) Applicant: Microchip Technology Incorporated, Chandler, AZ (US)

(72) Inventors: Venkatraman Iyer, Austin, TX (US); Elhossin Elshafey, Cork (IE); Dixon Chen, Shenzhen (CN)

(21) Appl. No.: 19/138,075

(22) PCT Filed: Jul. 17, 2024
(86) PCT No.: PCT/CN2024/105841

§ 371 Date: Jun. 11, 2025

Related U.S. Application Data
(63) Continuation of application No. PCT/CN2023/107648, filed on Jul. 17, 2023.

(51) Int. Cl. G06F 13/22

(52) U.S. Cl. CPC G06F 13/22; G06F 2213/40

(57) ABSTRACT

Examples include managing address space in a register bank of a system basis chip. An apparatus includes a bus slave and a system basis chip including a register bank, an access controller to confine reach of the bus slave to a select set of addresses of the register bank, and an address space manager to set the select set of addresses of the register bank.

### CROSS-REFERENCE TO RELATED APPLICATIONS

This application is a national phase entry under 35 U.S.C. § 371 of International Patent Application PCT/CN2024/105841, filed Jul. 17, 2024, designating the United States of America and published as International Patent Publication WO 2025/016390 A1 on Jan. 23, 2025, which claims the benefit under Article 8 of the Patent Cooperation Treaty of Chinese Patent Application Serial No. PCT/CN2023/107648, filed Jul. 17, 2023.

### FIELD

Examples relate, generally, to a 10SPE physical layers (PHY). Some examples relate, generally, to a system-basis-chip that implement a transceiver of a 10SPE PHY and a microcontroller that implements a controller of the 10SPE PHY. Some examples relate, generally, to a system-basis-chip that manages address space in a register bank of the system basis chip.

### BACKGROUND

Integrated circuits (ICs) are utilized in a variety of operational context and may be subject to a variety of stresses.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. To easily identify the discussion of any particular element or act, the most significant digit or digits in a reference number refer to the figure number in which that element is first introduced.

FIG. 1 is a block diagram depicting a system and an architecture of a system basis chip (SBC) designed to manage register access and extend the address space of a 10BASE-T1S transceiver, in accordance with one or more examples.

FIG. 2 is a block diagram of a system that includes a system basis chip and microcontroller, in accordance with one or more examples.

FIG. 3 is schematic diagrams depicting example formats for an MDIO bitstream and an I2C bitstream received at MDIO slave with address space management and I2C slave, respectively, in accordance with one or more examples.

FIG. 4 is a schematic diagram depicting examples of specific use registers in accordance with one or more examples,

FIG. 5A is a schematic diagram depicting a register bank or a portion thereof, in an example environment, and in accordance with one or more examples.

FIG. 5B is a schematic diagram further illustrating the structure of the register bank in an example environment.

FIG. 6 illustrates an example process for representing behavior of an access control logic to enable modification of address allocations within a system basis chip or address controller thereof, in accordance with one or more examples.

FIG. 7 is a flow diagram depicting the process of adding non-native register addresses to the address allocation for the MDIO slave, extending its accessible register space, in accordance with one or more examples.

FIG. 8 is a flow diagram depicting a process of validating address access requests to ensure they fall within the authorized address allocation, in accordance with one or more examples.

FIG. 9 illustrates an aspect of the subject matter, in accordance with one or more examples.

FIG. 10 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples discussed herein. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of this disclosure but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of this disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code, without limitation) related to examples discussed herein.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description, the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

As used herein, the terms “assert,” “de-assert” and derivatives thereof used in reference to a pin, means, respectively, to assert or de-assert a signal associated with the pin (e.g., a signal specifically assigned to the pin or a signal to which the pin is specifically assigned, without limitation).

A system basis chip (SBC) is an integrated circuit (IC) that combines multiple functions for operation of an electronic system. An SBC typically integrates various, different functions into a single chip, including, as non-limiting examples: power management functions such as voltage regulators, power switches, or protection circuitry, without limitation, to manage the power supply for the system, communication interfaces such as CAN (Controller Area Network), LIN (Local Interconnect Network), SPI (Serial Peripheral Interface), or I2C (Inter-Integrated Circuit), without limitation; embedded systems such as state machines or microprocessors, without limitation, that control and coordinate tasks; analog functions such as analog-to-digital converters (ADCs), digital-to-analog converters (DACs), temperature sensors, and other signal conditioning circuitry; and diagnostic and safety functions, such as monitoring and reporting voltage levels, temperature, or fault conditions, without limitation.

SBCs are found in a variety of operational context, including automotive and industrial applications. A non-limiting example of an automotive application for SBC is in 10SPE (i.e., 10 Mbps Single Pair Ethernet) networks (also called “10BASE-T1S networks”). 10SPE is a network technology specified in IEEE 802.3 clause 147 and 148. 10SPE may be used to provide a collision free, deterministic transmission on a multi-drop network.

In some cases, a transceiver (xcvr) and controller of a 10SPE physical layer device (PHY) may be located on different die, as a non-limiting example, so the die undergo different processing conditions. Such an architecture is referred to herein as a “split-PHY” architecture. The digital blocks of the PHY controller, which are susceptible to damage during high voltage temperature processes, are located on a first die that does not undergo high voltage temperature processes. Analog and digital blocks of the PHY transceiver, which are not susceptible to damage during high voltage temperature processes or require such high voltage temperature processes are located on a second die that does undergo such high voltage temperature processes.

The 10SPE Transceiver Interface standard currently under specification development by Technology Committee 14 of the Open Alliance (hereinafter the “TC14”) defines a hardware interface (specifically, a 3-pin hardware interface) for communication between a PHY transceiver and a PHY controller if a split-PHY architecture.

In 10SPE, a microcontroller (MCU) implements the PHY controller functions and an SBC implements the PHY transceiver functions, In 10SPE, the SBC's non-transceiver responsibilities include regulated power delivery, observability/control of high-voltage domain, and functional safety mechanisms for MCU to reach safe state. So, in addition to transceiver functions, the SBC implements functions of the electronic system, such as power management, watchdog circuit, monitors, general purpose input/output (GPIO), without limitation.

TC14 describes low-power (sleep-wake) behavior of the PHY transceiver for partial networking. Partial networking refers to a feature that enables selective power management and communication capabilities within a network. Partial networking allows certain network nodes or devices to enter a low-power state or sleep state while still maintaining basic communication functionality. In Ethernet networks, partial networking is utilized to optimize power consumption, particularly in automotive or industrial applications. Allowing selected devices to enter a low-power state or sleep-state, may reduce overall power consumption, extend battery life, or improves energy efficiency, without limitation.

The System Basis Chip (SBC) incorporates a 10BASE-T1S transceiver that requires expanded register space due to the limited number of vendor-specific registers defined by the Open Alliance (OA) specification. The OA specification allows access to 32 registers via the Management Data Input/Output (MDIO) interface, of which only 15 are available for vendor-specific use. Sometimes it may be desirable to have additional registers for, such as non-limiting examples, tuning, test, eFuse, and debug, without limitation.

One or more examples relate, generally, to managing address spaces in a register bank of an SBC that implements 10BASE-T1S transceiver. An SBC that implements 10BASE-T1S transceiver is capable of extending a register space associated with the 10BASE-T1S transceiver beyond the 32 registers defined by the OA specification and manages indirect access to other register spaces within the SBC.

In one or more examples, the SBC utilizes at least two of the 15 vendor-specific registers to act as control/address and data registers, allowing access to an extended register space beyond the 32 registers specified in the OA specification. One of the at least two registers is utilized as a control register and includes fields for read/write control and the address of the extended configuration register. Another one of the at least two registers is utilized as a data register and holds the data to be written to or read from the extended register specified by the control register.

In one or more examples, an SBC includes a bank of registers divided (e.g., logically divided, physically divided, or both, without limitation) into at least two groups: a first group of registers accessible by an MDIO driver and a second, different group of registers accessible by an I2C driver. The MDIO driver handles access to registers in the transceiver-specific address space, and an I2C driver manages access to registers for non-transceiver functions such as power delivery and watchdog features, utilizing a separate register space (e.g., a register space that is different than the transceiver-specific address space).

In some cases, respective firm wares of the MDIO driver and I2C driver may have a list of resources, including register addresses, the firmware may utilize. However, in some cases, firmware may be customizable so could be violated by unauthorized access. In one or more examples, the SBC includes a hardware lockout to sure that cross-access between MDIO and I2C accessible register spaces is prevented during normal operation to maintain security and integrity. Attempting access to the wrong resources triggers a violation and hardware at the SBC would prevent the access from completing. In this way, the SBC-specific registers are not accessible via the MDIO driver and the transceiver-specific registers are not accessible via the I2C.

In one or more examples, a hardware lockout may be temporarily disabled utilizing, as a non-limiting example, a specific set or sequence of cryptographic keys (“access keys”). It may be desirable to disable hardware lock, as non-limiting examples, for debugging, testing, or programming, without limitation. Access keys turn off hardware lockout and thus unlock cross accessibility of registers by the MDIO driver and the I2C driver.

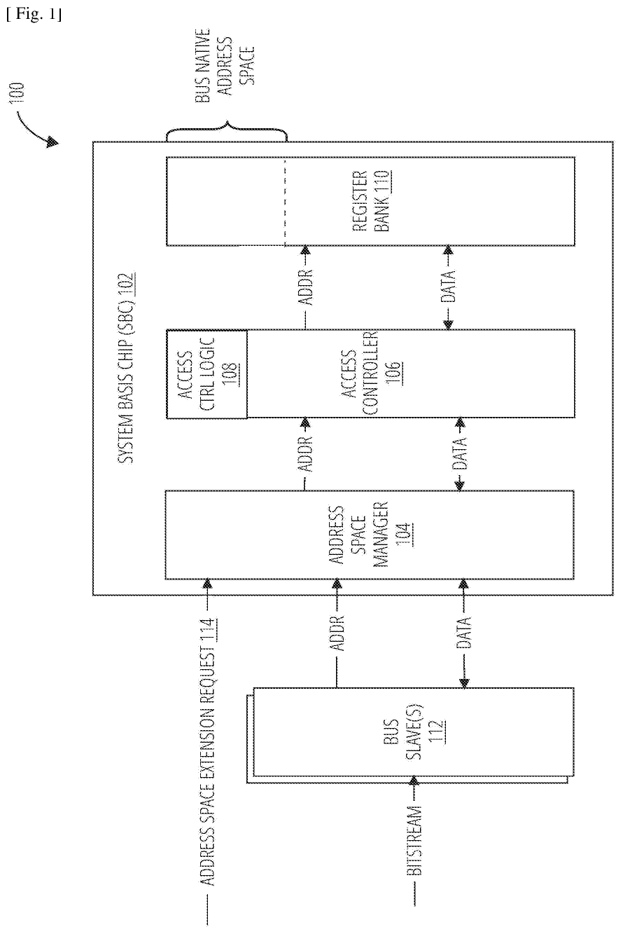

FIG. 1 is a block diagram depicting a system 100 and an architecture of a system basis chip (SBC) designed to manage register access and extend the address space of a 10BASE-T1S transceiver, in accordance with one or more examples.

System 100 includes a System Basis Chip (SBC) 102 and one or more bus slaves 112. The System Basis Chip 102 includes an address space manager 104, an access controller 106, and a register bank 110. The access controller 106 includes access control logic 108.

Bus slave(s) 112 is a device that operates as a peripheral or subordinate to a bus master in a computer or electronic communication system.

In a bus-based architecture, the electronic communication system, data, and control signals may be transferred between respective ones of bus slave(s) 112 (via bitstreams) and between bus slave(s) 112 and bus masters using a bus. Bus slave(s) 112 monitor a bus (e.g., MDIO or I2C) for commands or requests addressed to them, process the received data or instructions, and provide the requested information or perform the requested actions. One or more of bus slave(s) 112 may be implemented at system basis chip (SBC) 102 or another device as needed.

One or more of the bus slave(s) 112 may be MDIO (Management Data Input/Output) bus slaves. Non-limiting examples of MDIO bus slaves include physical layer (PHY) transceivers, Ethernet switches (e.g., Gigabit Ethernet switches, without limitation), Network Interface Cards (NICs), Ethernet Media Converters, and Ethernet routers and gateways.

One or more of the bus slave(s) 112 may be an I2C (Inter-Integrated Circuit) bus slave. Non-limiting examples of I2C bus slaves include sensors, memory chips, or peripheral devices. One or more bus slaves of bus slave(s) 112 may be a PCI (Peripheral Component interconnect) bus system. Non-limiting examples of PCI bus slaves include a network card, sound card, or peripheral device. Bus slave(s) 112 monitor the bus for commands or requests addressed to it, processing the received data or instructions, and providing requested information or performing requested actions.

Address space manager 104 dynamically manages the accessibility of one or more busses to register bank 110. Address space manager 104 operates by adding or removing addresses from a select set of addresses in the register bank 110. The select set of addresses corresponds to a select portion of the register bank's address space that a bus (e.g., MDIO bus or I2C bus, without imitation) may interact with. In one or more examples, address space manager 104 manages accessibility of one or more busses to register bank 110 in response to an address space extension request 114. An address space extension request 114 may identify a bus slave (e.g., one of the bus slave(s) 112, without limitation) and include an identification of a desired address space extension (e.g., a number of additional registers or addresses or an amount of additional memory space, without limitation). For example, address space extension request 114 requesting extension of the transceiver-specific address space may identify a 10BASET1S transceiver and indicate a number of additional registers. In some cases, it may be desirable to reduce the extended address space of a bus slave (e.g., to free up space for another bus slave, without limitation) and so an address space extension request 114 may also identify a bus slave and include an identification of desired address space subtraction (e.g., a number of subtracted registers or address or an amount of subtracted memory space, without limitation). In one or more examples, the address space manager 104 will not reduce the address space below the bus native address space (e.g., a minimum number of addresses or registers in a specification, without limitation).

In this way, address space manager 104 effectively controls the range of registers of register bank 110 that a bus (or bus slave) has permission to read from or write to, providing flexibility and ensuring efficient utilization of the register bank's resources. As a non-limiting example, address space manager 104, in response to an address space extension request 114, adjusts the range of accessible addresses, effectively controlling which portions of the register bank a bus can interact with. This ensures flexibility and efficient utilization of the register bank's resources.

Access controller 106 confines the reach of a bus to the select addresses of register bank 110, which correspond to a select portion of the address space of register bank 110. Access controller 106 enforces an interaction boundary within register bank 110 for a given bus. It does this by blocking any attempts to interact with addresses that fall outside of the select set of addresses of the register bank's address space. This ensures that a given bus can only read from or write to the allocated range of addresses, as a non-limiting example, safeguarding the integrity of the other addresses within the register bank.

Access control logic 108 (“access ctrl logic 108”) of access controller 106 functions as a security mechanism for the expansion of the select set of addresses of the register bank 110 address space. In one or more examples, access ctrl logic 108 only permits the address space manager 104 to add or remove addresses to or from the select set of addresses if a correct set of access keys is provided. This key-based validation process ensures the secure and controlled extension of the accessible address space, preventing unauthorized or inadvertent modifications. So, for specific address space or portions of the register bank, access ctrl logic 108 is aware of predefined sequences or sets of digital keys that respectively authorize any changes to address spaces. Access ctrl logic 108 is also aware of the current states of respective address spaces, including which addresses are currently part of the select set.

A bus native address is an address (e.g., an address in a bus slave such as of a register in register bank 110, without limitation) that may be directly accessed by a respective bus master. As used herein, the term “directly accessed” (and derivatives thereof) means accessed utilizing a single access operation (e.g., a single read or write operation, without limitation), and the term “directly accessible” means accessible utilizing a single access operation. As a non-limiting example of a directly accessed address: an address is placed on the address line, decoded at the register bank, and data is read from or written to the data line. This direct approach allows for uniform firmware driver operations. In contrast to a native address, an extendable address is an address (e.g., of registers in register bank 110, without limitation) that requires more than a single access operation to be accessed. Extendable addresses are not directly accessible in a single step and involve additional stages, such as utilizing a register as a staging register.

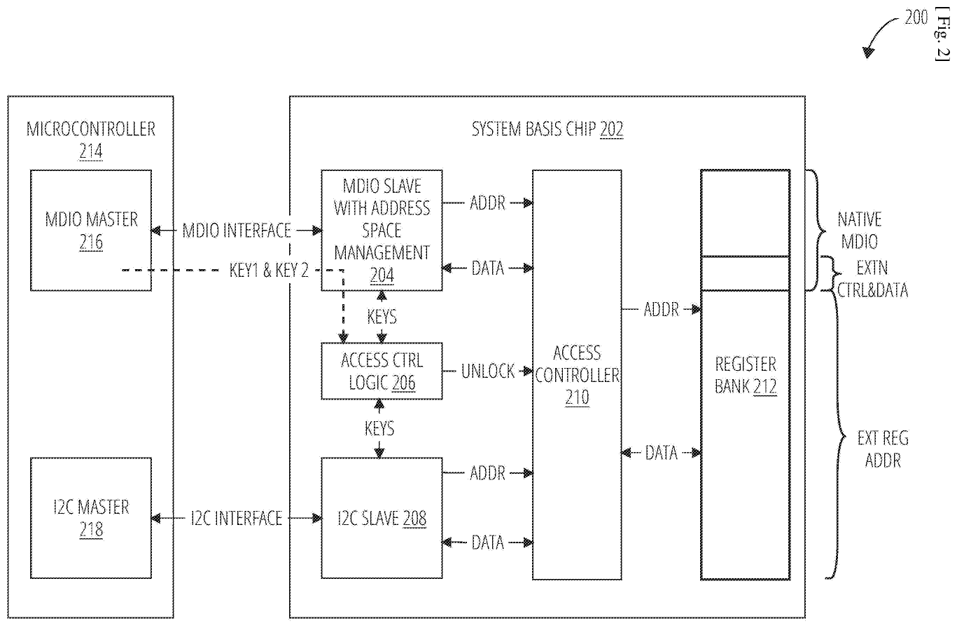

FIG. 2 is a block diagram of a system 200. System 200 includes a system basis chip 202 and Microcontroller 214. The system basis chip 202 includes MDIO slave with address space management 204, access ctrl logic 206, I2C slave 208, access controller 210, and register bank 212. Microcontroller 214 includes MDIO master 216 and I2C master 218.

MDIO slave with address space management 204 is an MDIO bus slave and an address space manager (e.g., address space manager 104 of FIG. 1). Access ctrl logic 206 is a non-limiting example of access ctrl logic 108 of FIG. 1. Access controller 210 is a non-limiting example of an access controller 106 of FIG. 1. Register bank 212 is a non-limiting example of register bank 110 of FIG. 1.

System basis chip 202 integrates both register bank 212 and a PHY transceiver (xcvr logic nor finite-state-machine are not depicted) and offers a flexible address space allocation mechanism. Initially, a distinct portion of the address space of register bank 212 is dedicated exclusively to the MDIO bus/PHY transceiver and a distinct portion of the address space of register bank 212 is dedicated exclusively to I2C slave 208. The system basis chip 202 offers dynamic address space management (including without limitation adding or subtracting address spaces within the select address space set).

This allows some or all of the I2C slave 208 allocated address space (termed “extended register addresses” or “ext reg addr” in FIG. 2) which may include some or all of the SBC's address space for non-PHY transceiver specific functions, to be made accessible to the MDIO slave, extending the range of addresses the MDIO can interact with. The allocation process is controlled by an address space manager (e.g., an address space manager 104, without limitation), here, integrated with the MDIO slave, but it may be a separate logic block (e.g., not integrated with the MDIO slave, without limitation). The allocation process is regulated by access ctrl logic 206, thereby maintaining secure and controlled access to the resources of register bank 212 for the purpose of extending or reducing address space. Access ctrl logic 206 ensures secure and controlled access to the register bank by verifying the provided keys and validating address space modifications. A signal line for an unlock indication (UNLOCK) is shown between access ctrl logic 206 and access controller 210. The unlock signal is used to control the modification of address allocations. In one or more examples, address allocations may be maintained, as a non-limiting example, at an address domain table of the MDIO slave or an extended domain table. The access ctrl logic 206 requires a correct set of keys to generate the unlock signal. Once validated, the unlock signal enables the MDIO slave with address space management 204 (part of the MDIO slave) to modify the address space, such as adding or removing addresses. In various examples, a first value of the unlock signal may enable modification of the address allocations and a second, different (different than the first value) value of the unlock signal may disable modifications to the address allocations.

By way of non-limiting examples, adjusting address allocations may include updating control registers or a table (e.g., extended register control & data (denoted “EXTN CTRL & DATA” in FIG. 1), without limitation) to include new addresses within the MDIO allocation. Adjusting address allocations may also include updating control registers or a table to set a register to be a staging register to access one or more extended registers, as discussed below. Adjusting the address allocation may also include updating (may optionally include) control registers or a table to remove addresses from the I2C allocation.

MDIO slave with address space management 204 is responsible for managing the register space accessible via the MDIO interface. As discussed above, this may include a transceiver-specific address spaces. Signal lines are shown for address (addr) and data (data) between MDIO slave with address space management 204 and access controller 210 and between I2C slave 208 and access controller 210. Signals on the address line specify the register address in the register bank 212 that is to be accessed (read from or written to), and signals on the data line carry the actual data to be written to or read from the specified register address. In a contemplated example, MDIO slave with address space management 204 or I2C slave 208 slave receives address information from the MDIO master 216 or I2C master 218 and uses this signal to identify specific registers in the register bank 110.

This structure provides a high degree of flexibility and efficiency in managing the register bank's address space, making it adaptable to the changing requirements of the system basis chip's operation or the MDIO slave's operation.

Register bank 212 includes some specific-use registers: a command register and a lock control register, bits of which are used to control access to. and allocation of portions of the address space of register bank 212. This setup allows for flexible, controlled, and secure access to and manipulation of the registers within the bank, especially for extended or indirect access cases.

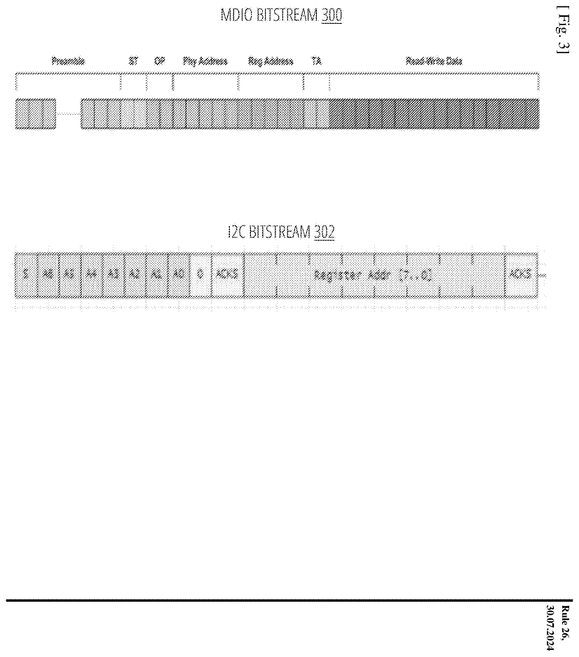

FIG. 3 is schematic diagrams depicting example formats for an MDIO bitstream 300 and an I2C bitstream 302 received at MDIO slave with address space management 204 and I2C slave 208, respectively, in accordance with one or more examples.

MDIO and I2C have a respective data line and one clock line. (clock line not shown). Since they have one respective data line, data is received as a bitstream, in the format of MDIO bitstream 300 and I2C bitstream 302.

Turning to MDIO bitstream 300, bits #1 to #8 are preamble bits, a sequence that prepares the MDIO slave for incoming data. Bit #9 is the start sequence, signaling the beginning of the MDIO frame. Bits #11 and #12 specify the operation type, such as read or write. The next four bits (bits #13-#16) denote the physical address, identifying which MDIO device the command is intended for. The next five bits (bits #17-#21) are the register address within the target device. The remaining bits are the data payload for the operation.

Turning to I2C bitstream 302, the I2C bitstream begins with a start bit, indicating the commencement of communication. The start bit is followed by a 7-bit address field, which specifies the I2C slave device address. The next bit indicates the operation type (read or write). The next bit is an acknowledge bit that is sent by the I2C slave to confirm receipt of the address. The next bits contain the data payload, to be transferred, either read from or written to the I2C slave device. The last bit of I2C bitstream 302 is a stop bit, marking the conclusion of the communication.

Both MDIO drivers and I2C drivers utilize bitstreams for data transfer, ensuring synchronized communication via a single data line and an accompanying clock line (not shown). The MDIO bitstream 300 and I2C bitstream 302, their respective formats and bits values, allow for accessing and managing the register spaces within the SBC, which allows for precise control and data transfer to and from the MDIO and I2C slaves.

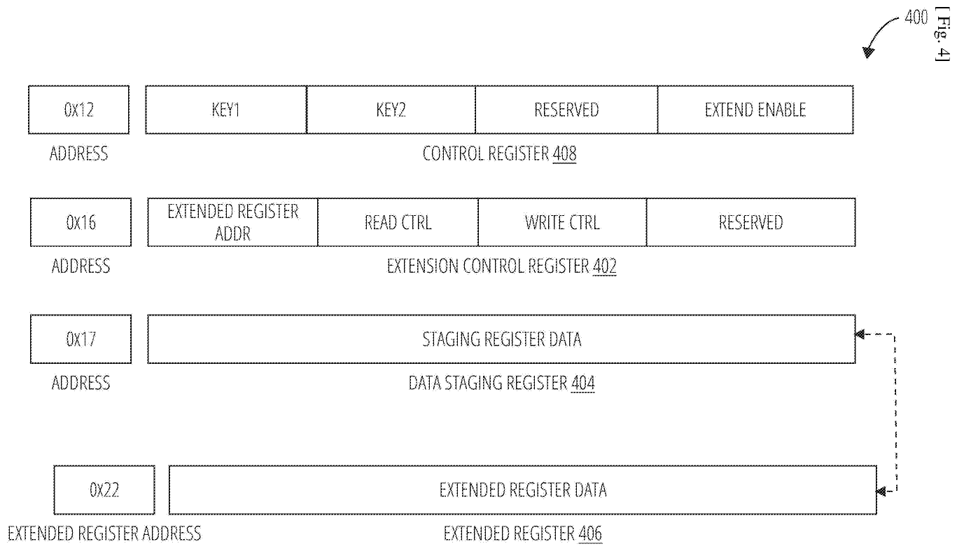

FIG. 4 is a schematic diagram depicting examples of specific use registers 400, in accordance with one or more examples.

FIG. 4 illustrates the structure and function of example specific use registers 400 within the SBC, including the control register, extension control register, and data staging register. These registers are utilized in managing extended address space and ensuring secure and flexible access to the register bank's resources. The control register handles key-based security mechanisms, the extension control register manages read/write operations for extended addresses, and the data staging register facilitates indirect data access.

Control register 408: This register includes three key-related fields: the first key bit, the second key bit, and an enable bit. The first key bit indicates whether the first key (key1) has been received. It resets (or is cleared) on any write to a specific register named SFTR, except when writing to key2. The second key bit signifies the receipt of the second key (key2). It allows write access to the SFTR register when both key 1 and key2 are “1.” This bit also resets on any write to another specific register, SFIRm. The enable bit functions as a control signal for Firmware (FW) access to all Control Status Register (CSR) bits in an indirect domain. When set to “1,” it enables FW access, and when set to “0,” it disables FW access. Before enabling or disabling this bit, specific key values need to be written to the SFTR register: SFTR key1 (16′h4149) followed by SFTR key2 (16′h4155), as non-limiting examples. SFTR and SFTRm are not shown.

Extension control register 402: This register comprises several fields, including an extended address field, a read ctrl, and a write ctrl. The extended register address field is used to hold an address that is part of the select portion of the register bank's address space. The read ctrl serves as a control signal. When this bit is set to “1,” the data stored in the extended register 406, referenced by the extended register address stored at extension control register 402, can be read from the data staging register 404. The write ctrl functions similarly. When it is set to “1,” the data held in the data staging register 404 will be written to the extended register 406 associated with the current extended address.

Data staging register 404 may be a memory mapped register. In one or more examples, system basis chip 202 or a peripheral device (not shown) maps specific addresses in register bank 212 (the extended address space of register bank 212) to various registers, allowing direct access to these registers through standard memory read and write operations. As a non-limiting example, an address decoding mechanism is provided that maps unique addresses to specific registers of register bank 212.

“Reserved” fields are depicted to illustrate that not all fields in the specific use registers need be used solely for address space allocation and access control discussed herein, though they may be used.

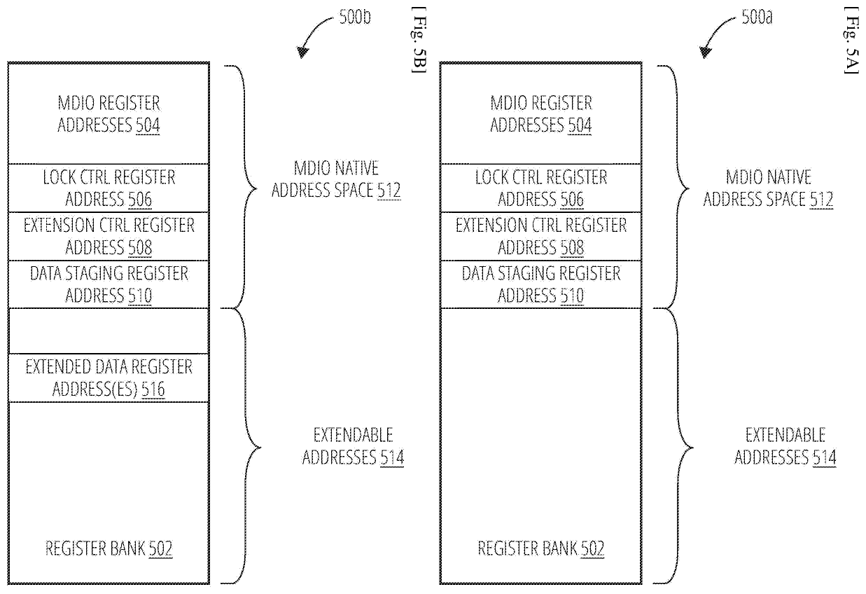

FIG. 5A is a schematic diagram 500a depicting a register bank 502 or a portion thereof, in an example environment, and in accordance with one or more examples.

Register bank 502 includes allocated MDIO native address space 512 and extendable addresses 514. The MDIO native address space 512 comprises various key register addresses for managing MDIO operations and secure access. In this specific example, MDIO native address space 512 includes MDIO register addresses 504, lock ctrl register address 506, extension ctrl register address 508 and data staging register address 510.

Register bank 502 is the primary storage area for configuration and operational registers within the System Basis Chip (SBC). MDIO Native Address Space 512 is the portion of the register bank dedicated to addresses natively accessible via the MDIO interface. MDIO register addresses 504 are standard addresses used for typical MDIO operations, such as configuration and status monitoring. Lock ctrl register address 506 is utilized to control access permissions and lock or unlock specific portions of the register bank. Extension ctrl register address 508 manages the extension of the address space, including controlling read and write operations to extended addresses. Data staging register address 510 acts as an intermediary for data transfer, staging data to be read from or written to the extended register space. Extendable addresses 514 are initially outside the native MDIO address space but can be dynamically allocated to it.

After an address allocation process, extended data register address(es) 516 become logically part of the MDIO native address space 512 and are accessible via the data staging register address 510. Extension ctrl register address 508 and lock ctrl register address 506 allow for managing access and secure modification of the register bank's address space. Data staging register address 510 facilitates the indirect access of extended addresses, ensuring seamless data transfer between the extended and native address spaces.

Notably extendable addresses 514 includes extended data register address(es) 516, which is now, after an address allocation process, logically part of MDIO native address space 512, because it is accessible via data staging register address 510.

FIG. 5B is a schematic diagram 500b further illustrating the structure of the register bank 502 in an example environment. FIG. 5B highlights that the extendable addresses 514, once allocated, integrated into the MDIO native address space 512, becomes accessible as part of the overall register space managed by the System Basis Chip (SBC). Like part numbers carry like descriptions from as the description of FIG. 5B. Notably, extendable addresses 514, initially outside the native address space, can be reallocated to extend the MDIO addressable space. Further, extended data register address(es) 516, after reallocation, these addresses integrate into the MDIO native address space 512, making them accessible via the data staging register address 510.

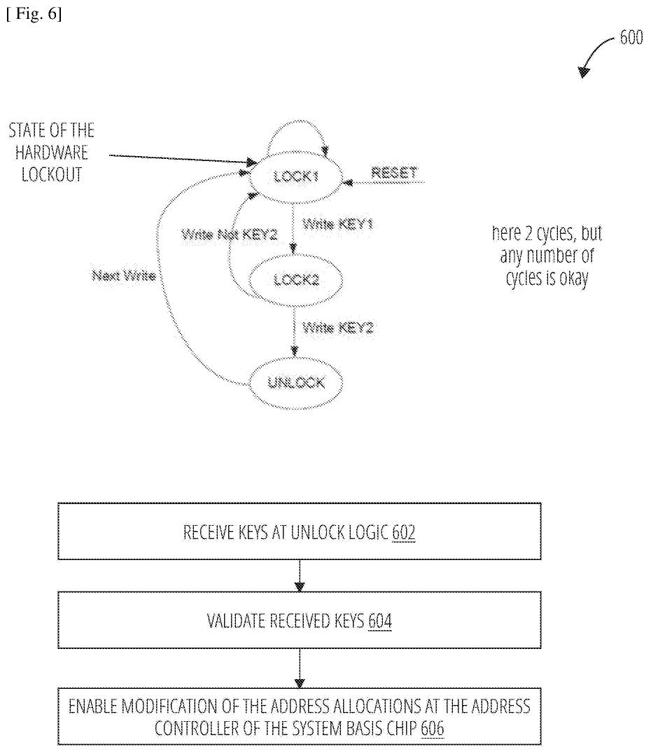

FIG. 6 illustrates an example process 600 for representing behavior of an access control logic to enable modification of address allocations within a system basis chip or address controller thereof, in accordance with one or more examples. Although the example process 600 depicts a particular sequence of operations, the sequence may be altered without departing from the scope of the present disclosure. For example, some of the operations depicted may be performed in parallel or in a different sequence that does not materially affect the function of the process 600. In other examples, different components of an example device or system that implements the process 600 may perform functions at substantially the same time or in a specific sequence. One or more operations of process 600 may be performed, as non-limiting examples, by access control access ctrl logic 108, access ctrl logic 206, access controller 106, access controller 210, system basis chip (SBC) 102, system basis chip 202, system 100, or system 200.

The system starts process 600 with the hardware lockout enabled, preventing unauthorized changes to the address allocations.

According to one or more examples, process 600 may include receiving keys at unlock logic at operation 602. The SBC receives a set of keys at the unlock logic. These keys, if validated, are for authorizing changes to the address space of a requestor.

According to one or more examples, process 600 may include validating received keys at operation 604. In one or more examples, the unlock logic validates the received keys to ensure they match expected values. Only if the keys are correct and validated can process 600 proceed to enabling modification.

If the keys are not validated (e.g., validation is not successful, without limitation) then the hardware lockout remains enabled and no modifications to the address allocations can be made. The Address controller of the SBC continues to prevent unauthorized changes, maintaining the integrity and security of the register bank's address space. Optionally, in one or more examples, there may be an error handling mechanism to log the failed attempt or trigger a security alert. This ensures that any unauthorized attempt to modify the address space is recorded and can be addressed appropriately.

According to one or more examples, process 600 may include enabling modification of the address allocations at the address controller of the system basis chip at operation 606. Upon successful validation of the keys, the unlock logic signals the address controller. The address controller is then enabled to modify the address allocations, allowing secure changes to the address space within the register bank.

In one or more examples, keys may be received over one or more cycles as needed. By way of specific non-limiting example, unlock logic may proceed through two verification states: lock 1 and lock 2. It transitions from lock 1 to lock 2 when key 1 is written, and from lock 2 to unlock when key 2 is written. If keys are not written or not written in a predetermined number of clock cycles, a finite state machine of unlock logic transitions from lock 2 to lock 1. Process 600 may, optionally, perform this behavior every time a read or write is initiated or once and then stay in an unlock state until a reset is received.

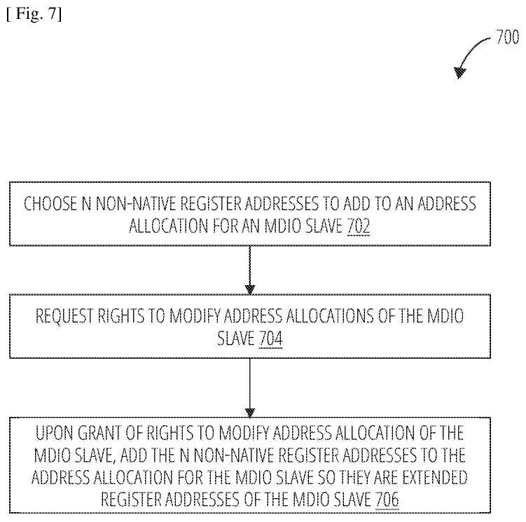

FIG. 7 is a flow diagram depicting the process of adding non-native register addresses to the address allocation for the MDIO slave, extending its accessible register space, in accordance with one or more examples. Although the example process 700 depicts a particular sequence of operations, the sequence may be altered without departing from the scope of the present disclosure. For example, some of the operations depicted may be performed in parallel or in a different sequence that does not materially affect the function of the process 700. In other examples, different components of an example device or system that implements the process 700 may perform functions at substantially the same time or in a specific sequence. One or more operations of process 700 may be performed, as non-limiting examples, by access control access ctrl logic 108, access ctrl logic 206, address space manager 104, MDIO slave with address space management 204, access controller 106, access controller 210, system basis chip (SBC) 102, system basis chip 202, system 100, or system 200.

According to one or more examples, process 700 may include choosing N non-native register addresses to add to an address allocation for an MDIO slave at operation 702. Process 700, in operation 702, selects a set of N non-native register addresses that need to be added to the MDIO slave's address allocation. N is an integer greater than or equal to 1.

According to one or more examples, process 700 may include requesting rights to modify address allocations of the MDIO slave at operation 704. A request is made to obtain the necessary rights to modify the address allocations. This step ensures that only authorized modifications are made to the MDIO slave's address space.

In some instances, the request to modify address allocations may be denied. If the request to modify the address allocations is denied, then no changes to the address space are made. The integrity and security of the existing address space are preserved, preventing unauthorized or unintended modifications. Optionally, an error handling mechanism may log the failed attempt or trigger a notification. This ensures that any unauthorized or failed attempt to modify the address space is recorded and can be addressed appropriately.

According to one or more examples, process 700 may include, upon grant of rights to modify address allocation of the MDIO slave, adding the n non-native register addresses to the address allocation for the MDIO slave so they are extended register addresses of the MDIO slave at operation 706. If the request for rights to modify the address allocations is granted, the selected non-native register addresses are added to the MDIO slave's address allocation. These addresses become extended register addresses for the MDIO slave, expanding its accessible register space.

By way of non-limiting examples, modifying address allocations may include updating control registers or a table to include new addresses within the MDIO allocation. Modifying the address allocation may also include updating (may optionally include) control registers or a table to remove addresses from the I2C allocation.

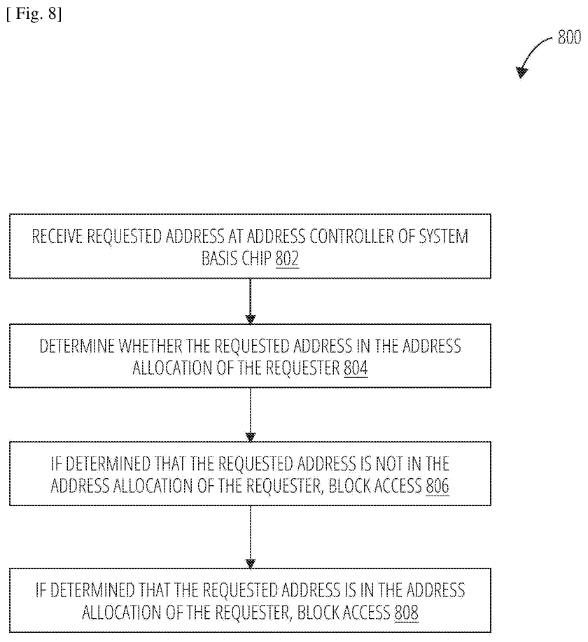

FIG. 8 is a flow diagram depicting a process 800 of validating address access requests to ensure they fall within the authorized address allocation, in accordance with one or more examples. Although the example 800 depicts a particular sequence of operations, the sequence may be altered without departing from the scope of the present disclosure. For example, some of the operations depicted may be performed in parallel or in a different sequence that does not materially affect the function of the 800. In other examples, different components of an example device or system that implements the 800 may perform functions at substantially the same time or in a specific sequence. One or more operations of 800 may be performed, as non-limiting examples, by access control access ctrl logic 108, access ctrl logic 206, address space manager 104, MDIO slave with address space management 204, access controller 106, access controller 210, system basis chip (SBC) 102, system basis chip 202, system 100, or system 200.

According to some examples, the method includes receiving requested address at address controller of system basis chip at operation 802. The address controller of the SBC receives a request containing the address that the requester intends to access.

According to some examples, the method includes determining whether the requested address is in the address allocation of the requester at operation 804. The address controller checks if the requested address is within the address allocation assigned to the requester. This step ensures that only authorized addresses can be accessed.

According to some examples, the method includes if determined that the requested address is not in the address allocation of the requester, block access at operation 806. If the requested address is not within the authorized address allocation, the access is blocked. This prevents unauthorized access to protected registers.

According to some examples, the method includes if determined that the requested address is in the address allocation of the requester, block access at operation 808. If the requested address is within the authorized address allocation, access is granted. The requester can then read from or write to the specified address, as permitted.

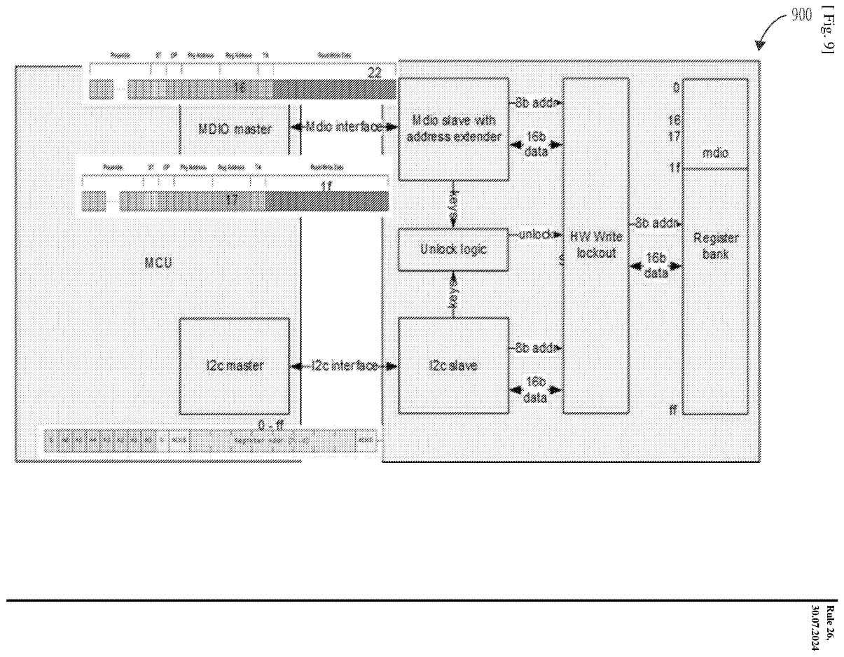

FIG. 9 is a block diagram depicting a system that is a specific non-limiting example of system 200.

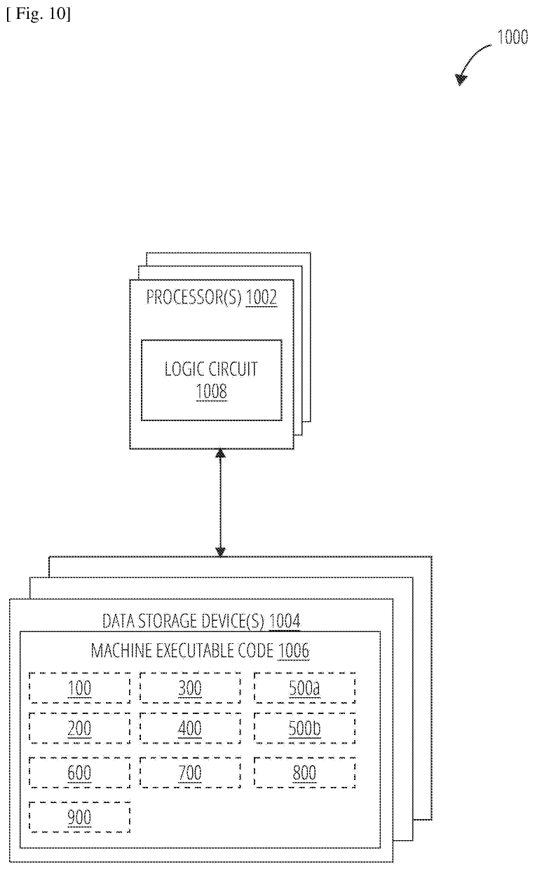

It will be appreciated by those of ordinary skill in the art that functional elements of examples disclosed herein (e.g., functions, operations, acts, processes, or methods) may be implemented in any suitable hardware, software, firmware, or combinations thereof. FIG. 10 illustrates non-limiting examples of implementations of functional elements disclosed herein. In some examples, some or all portions of the functional elements disclosed herein may be performed by hardware capable of carrying out the functional elements.

FIG. 10 is a block diagram of a circuitry 1000 that, in some examples, may be used to implement various functions, operations, acts, processes, or methods disclosed herein. The circuitry 1000 includes one or more processors 1002 (sometimes referred to herein as “processors 1002”) operably coupled to one or more data storage devices 1004 (sometimes referred to herein as “storage 1004”). The storage 1004 includes machine-executable code 1006 stored thereon and the processors 1002 include logic circuit 1008. The machine-executable code 1006 information describes functional elements that may be implemented by (e.g., performed by) the logic circuit 1008. The logic circuit 1008 is adapted to implement (e.g., perform) the functional elements described by the machine-executable code 1006. The circuitry 1000, when executing the functional elements described by the machine-executable code 1006, should be considered as special purpose hardware for carrying out functional elements disclosed herein. In some examples, the processors 1002 may perform the functional elements described by the machine-executable code 1006 sequentially, concurrently (e.g., on one or more different hardware platforms), or in one or more parallel process streams.

When implemented by logic circuit 1008 of the processors 1002, the machine machine-code 1006 adapts the processors 1002 to perform operations of examples disclosed herein. By way of non-limiting example, the machine-executable code 1006 may adapt the processors 1002 to perform some or a totality of operations of processes for managing address space in a register bank of a system basis chip.

Also, by way of non-limiting example, the machine-executable code 1006 may adapt the processors 1002 to perform some or a totality of features, functions, or operations disclosed herein for managing address space in a register bank of a system basis chip or utilizing the same.

The processors 1002 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable code 1006 (e.g., software code, firmware code, hardware descriptions) related to examples discussed herein. It is noted that a general-purpose processor (may also be referred to herein as a host processor or simply a host) may be a microprocessor, but in the alternative, the processors 1002 may include any conventional processor, controller, microcontroller, or state machine. The processors 1002 may also be implemented as a combination of computing devices, such as a combination of a DSP and a microprocessor, a plurality of microprocessors, one or more microprocessors in conjunction with a DSP core, or any other such configuration.

In some examples, the storage 1004 includes volatile data storage (e.g., random-access memory (RAM)), non-volatile data storage (e.g., Flash memory, a hard disc drive, a solid-state drive, erasable programmable read-only memory (EPROM), without limitation). In some examples, the processors 1002 and the storage 1004 may be implemented into a single device (e.g., a semiconductor device product, a system on chip (SOC), without limitation). In some examples, the processors 1002 and the storage 1004 may be implemented into separate devices.

In some examples, the machine-executable code 1006 may include computer-readable instructions (e.g., software code, firmware code). By way of non-limiting example, the computer-readable instructions may be stored by the storage 1004, accessed directly by the processors 1002, and executed by the processors 1002 using at least the logic circuit 1008. Also, by way of non-limiting example, the computer-readable instructions may be stored on the storage 1004, transferred to a memory device (not shown) for execution, and executed by the processors 1002 using at least the logic circuit 1008. Accordingly, in some examples, the logic circuit 1008 includes electrically configurable logic circuit 1008.

In some examples, the machine-executable code 1006 may describe hardware (e.g., circuitry) to be implemented in the logic circuit 1008 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog or very large-scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 1008 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, the machine-executable code 1006 may include an HDL, an RTL, a GL description, a mask level description, other hardware description, or any combination thereof.

In examples where the machine-executable code 1006 includes a hardware description (at any level of abstraction), a system (not shown, but including the storage 1004) implements the hardware description described by the machine-executable code 1006. By way of non-limiting example, the processors 1002 may include a programmable logic device (e.g., an FPGA or a PLC) and the logic circuit 1008 may be electrically controlled to implement circuitry corresponding to the hardware description into the logic circuit 1008. Also, by way of non-limiting example, the logic circuit 1008 may include hard-wired logic manufactured by a manufacturing system (not shown, but including the storage 1004) according to the hardware description of the machine-executable code 1006.

Regardless of whether the machine-executable code 1006 includes computer-readable instructions or a hardware description, the logic circuit 1008 is adapted to perform the functional elements described by the machine-executable code 1006 when implementing the functional elements of the machine-executable code 1006. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C, B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: An apparatus, comprising: a bus slave; a system basis chip including: a register bank; an access controller to confine reach of the bus slave to a select set of addresses of the register bank, and an address space manager to set the select set of addresses of the register bank.

Example 2: The apparatus according to Example 1, wherein to set the select set of addresses of the register bank, the address space manager to: change addresses within the select set of addresses of the register bank.

Example 3: The apparatus according to any of Examples 1 and 2, wherein to change addresses within the select set of addresses of the register bank, the address space manager to: add or remove addresses from the select set of addresses of the register bank.

Example 4: The apparatus according to any of Examples 1 through 3, wherein to confine reach of the bus slave to the select set of addresses of the register bank, the access controller to: allow interaction of the bus slave with registers of the register bank that correspond to the select set of addresses of the register bank, and block interaction of the bus slave with registers of the register bank that correspond to addresses outside the select set of addresses of the register bank.

Example 5: The apparatus according to any of Examples 1 through 4, wherein the bus slave is a management data input/output bus slave.

Example 6: The apparatus according to any of Examples 1 through 5, wherein the select set of addresses of the register bank includes native addresses of the bus slave.

Example 7: The apparatus according to any of Examples 1 through 6, wherein the access controller to: permit the address space manager to change the select set of addresses of the register bank at least partially responsive to a key-based validation process.

Example 8: The apparatus according to any of Examples 1 through 7, comprising: a further bus slave, wherein the access controller to: confine reach of the further bus slave to a further select set of addresses of the register bank.

Example 9: The apparatus according to any of Examples 1 through 8, wherein a register of the register bank includes a first key field, a second key field, and an enable field, wherein the first key field to indicate whether or not a first key has been received and validated, wherein the second key field to indicate whether or not a second key has been received and validated, wherein the enable field to indicate whether or not firmware has access to a totality of bits of a control status register of the system basis chip.

Example 10: The apparatus according to any of Examples 1 through 9, wherein a register of the register bank includes an extended address field, a read field, and a write field, wherein the extended address field to hold an extended address in the select set of addresses of the register bank, the extended address associated with an extended register; wherein the read field to indicate whether or not data may be read from the extended register via a data staging register; and wherein the read field to indicate whether or not data may be written to the extended register via a data staging register.

Example 11: The apparatus according to any of Examples 1 through 10, wherein the extended register is a memory mapped register.

Example 12: The apparatus according to any of Examples 1 through 11, wherein the address space manager, responsive to a debug state of the system basis chip, to set the select set of addresses of the register bank to include a totality of an address space of the register bank.

Example 13: The apparatus according to any of Examples 1 through 12, comprising: a physical layer transceiver, wherein the access controller to: confine reach of the physic layer transceiver to a further select set of addresses of the register bank, wherein the selected set of addresses is different than the further select set of addresses.

Example 14: A method, comprising: choose N non-native register addresses to add to an address allocation for an MDIO slave; request rights to modify address allocations of the MDIO slave; and upon grant of rights to modify address allocation of the MDIO slave, add the N non-native register addresses to the address allocation for the MDIO slave so they are extended register addresses of the MDIO slave.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

1. An apparatus, comprising:
a bus slave;
a system basis chip including:
a register bank;
an access controller to confine reach of the bus slave to a select set of addresses of the register bank; and
an address space manager to set the select set of addresses of the register bank.

2. The apparatus of claim 1, wherein to set the select set of addresses of the register bank, the address space manager to:
change addresses within the select set of addresses of the register bank.

3. The apparatus of claim 2, wherein to change addresses within the select set of addresses of the register bank, the address space manager to:
add or remove addresses from the select set of addresses of the register bank.

4. The apparatus of claim 2, wherein to confine reach of the bus slave to the select set of addresses of the register bank, the access controller to:
allow interaction of the bus slave with registers of the register bank that correspond to the select set of addresses of the register bank; and
block interaction of the bus slave with registers of the register bank that correspond to addresses outside the select set of addresses of the register bank.

5. The apparatus of claim 1, wherein the bus slave is a management data input/output bus slave.

6. The apparatus of claim 1, wherein the select set of addresses of the register bank includes native addresses of the bus slave.

7. The apparatus of claim 1, wherein the access controller to:
permit the address space manager to change the select set of addresses of the register bank at least partially responsive to a key-based validation process.

8. The apparatus of claim 1, comprising:
a further bus slave,
wherein the access controller to:
confine reach of the further bus slave to a further select set of addresses of the register bank.

9. The apparatus of claim 1, wherein a register of the register bank includes a first key field, a second key field, and an enable field,
wherein the first key field to indicate whether or not a first key has been received and validated,
wherein the second key field to indicate whether or not a second key has been received and validated,
wherein the enable field to indicate whether or not firmware has access to a totality of bits of a control status register of the system basis chip.

10. The apparatus of claim 1, wherein a register of the register bank includes an extended address field, a read field, and a write field,
wherein the extended address field to hold an extended address in the select set of addresses of the register bank, the extended address associated with an extended register;
wherein the read field to indicate whether or not data may be read from the extended register via a data staging register; and
wherein the read field to indicate whether or not data may be written to the extended register via a data staging register.

11. The apparatus of claim 10, wherein the extended register is a memory mapped register.

12. The apparatus of claim 1, wherein the address space manager, responsive to a debug state of the system basis chip, to set the select set of addresses of the register bank to include a totality of an address space of the register bank.

13. The apparatus of claim 1, comprising:
a physical layer transceiver,
wherein the access controller to:
confine reach of the physical layer transceiver to a further select set of addresses of the register bank,
wherein the select set of addresses is different than the further select set of addresses.

14. A method, comprising:
choose N non-native register addresses to add to an address allocation for an MDIO slave;
request rights to modify address allocations of the MDIO slave; and
upon grant of rights to modify address allocation of the MDIO slave, add the N non-native register addresses to the address allocation for the MDIO slave so they are extended register addresses of the MDIO slave.
